(19) United States
(12) Patent Application Publication
(10) Pub. No.: US 2013/0120574 A1
(43) Pub. Date: May 16, 2013

(54) STATE MONITOR APPARATUS

(71) Applicant: DENSO CORPORATION, Kariya-city (JP)

(72) Inventor: Takuhiro Omi, Anjo-city (JP)

(73) Assignee: DENSO CORPORATION, Kariya-city (JP)

(21) Appl. No.: 13/671,925

(22) Filed: Nov. 8, 2012

(30) Foreign Application Priority Data
Nov. 10, 2011 (JP) 2011-246733

(51) Int. Cl. H04N 7/18

(52) U.S. Cl. CPC H04N 7/188
USPC 348/148

(57) ABSTRACT

In a state monitor process, it is determined whether a stop state, which requires a stop of a function of a state monitor apparatus, takes place based on detection signals from sensors, namely, it is determined whether an installed position of the state monitor apparatus is displaced from a fixing position or prespecified position. When the installed position of the state monitor apparatus is not displaced from the fixing position, it is determined that the stop state does not take place, permitting a light emitter to irradiate a defined irradiated area with near-infrared lights to capture an image of a driver. When the installed position of the state monitor apparatus is displaced from the fixing position, it is determined that the stop state takes place, executing a restriction process including a reduction process to reduce an emission of the near-infrared lights and a warning output process.

### CROSS REFERENCE TO RELATED APPLICATION

The present application is based on Japanese Patent Application No. 2011-246733 filed on Nov. 10, 2011, the disclosure of which is incorporated herein by reference.

### TECHNICAL FIELD

The present disclosure relates to a state monitor apparatus mounted to a vehicle.

### BACKGROUND ART

[Patent document 1] JP 2008-167806 A

A conventional driver monitoring system or state monitor apparatus monitors an occupant of a vehicle using a camera to achieve a safe travel of the vehicle, as described in Patent document 1.

Such a state monitor apparatus in Patent document 1 has a light emitter to emit near-infrared lights in a predetermined intensity level, an imager to capture an image, and a state monitor section to monitor a state of the occupant based on a result of image-processing of the image captured.

The light emitter is installed at a prespecified position to irradiate a defined irradiated area covering a face of the occupant of the vehicle with near-infrared lights. The imager is installed at a prespecified position that permits an image capture of a defined captured area, which is an area certainly covering a face of a driver.

The state monitor section image-processes the image captured to derive an opening degree of the driver's eyes for monitoring the driver's degree of arousal, or derive the driver's sight line for monitoring whether the driver looks aside during driving.

The state monitor apparatus may be displaced due to some causes such as vibration during the traveling of the vehicle from the prespecified position. That is, the actual installed position of the imager or light emitter may be displaced from the prespecified position.

When the installed position of the state monitor apparatus varies from the prespecified position, in particular, when the installed position of the light emitter is displaced from the prespecified position, a disadvantage may occur as follows. That is, the near-infrared lights emitted by the light emitter may radiate towards an area not covering the face of the occupant that serves as a monitor target. Alternatively, even when radiating to an area covering the occupant's face, the strength level of the near-infrared lights reaching the face may become too brighter or darker than a predetermined level, possibly capturing an image unsuitable for monitoring the occupant. Herein, the reason to use the light emitter in the state monitor apparatus is to stabilize luminance regardless of day or night. A supplemental lighting is necessary in response to the insufficient sensitivity of the imager at night. Further, not to interfere with the driving of the occupant, the near-infrared lights that are invisible are used as an illuminator.

In other words, in a conventional state monitor apparatus, when the installed position of the state monitor apparatus varies from the prespecified position, in particular, when the installed position of the light emitter is displaced from the prespecified position, an area out of an intended area covering an imaging target may be irradiated with the emitted light and/or image-captured. This precludes an intended function of the state monitor apparatus, while the light emitter remains emitting the near-infrared lights with a predetermined strength.

Furthermore, for the purpose of a usual check up of a vehicle, the state monitor apparatus may be removed from the fixing position, or the steering wheel of the vehicle may be removed from the steering column.

When an essential function of a vehicle, such as running, stopping, and turning are disabled, the vehicle is almost never driven. Thus, the state monitor apparatus, in particular, an operation of the light emitter is unnecessary for the purpose of a safe travel of the vehicle.

A conventional state monitor apparatus has no function to turn on/off from an instruction of a user; thus, turning on of the ignition switch causes the activation of the state monitor apparatus regardless of the occupant's intention.

As a result, in a conventional state monitor apparatus, even though it is unnecessary, the near-infrared lights are emitted in a predetermined strength, increasing uselessly the electricity consumption.

### SUMMARY

It is an object of the present disclosure to provide a state monitor apparatus to prevent electricity consumption more than necessary.

To achieve the above object, according to an aspect of the present disclosure, a state monitor apparatus in a vehicle is provided to include the following. A light emitter is to emit a light including a near-infrared light, the light emitter being to be installed at a prespecified position that permits the near-infrared light to be emitted towards a defined irradiated area that is defined as an area covering a face of an occupant of the vehicle. An imager is to capture an image of a defined captured area that is an area to cover at least partially the defined irradiated area. A state monitor section is to perform a monitoring to monitor an occupant state, which is a state of the occupant, based on a result from image-processing an image captured by the imager. A state determination section is to determine whether a stop state takes place which requires a stop of a function of the monitoring. A restriction execution section is to execute a restriction process to restrict a function of the light emitter when the stop state is determined to take place by the state determination section.

Under this configuration, when the stop state is determined to take place, a specific restriction process is executed, restricting the function of the light emitter to prevent the emission of the near-infrared light more than necessary and reducing the electricity consumption.

Further, the defined irradiated area may refer to an area in which the face of the occupant of the vehicle is located, such as an area covering a headrest of the seat of the occupant in an automobile; the prespecified position of the light emitter may refer to a position in a compartment of the vehicle, such as an upper portion of the steering column of the automobile.

According to another aspect of the present disclosure, a state monitor apparatus in a vehicle to monitor an occupant of the vehicle is provided to include the following. A light emitter is installed to a prespecified position for emitting a near-infrared light towards a compartment of the vehicle. A camera is to capture an image of an area which is irradiated by the light emitter with the near-infrared light. A controller is to control an emission of the light emitter and to stop or reduce the emission of the light emitter when it is determined that the light emitter is displaced from the prespecified position.

According to another aspect of the present disclosure, a method for controlling a state monitor apparatus in a vehicle is provided as follows. The apparatus includes a light emitter installed to a prespecified position; the light emitter performs an emission to emit a near-infrared light towards a compartment of the vehicle. The method includes: determining whether the light emitter is displaced from the prespecified position; and prohibiting or reducing the emission of the light emitter when it is determined that the light emitter is displaced from the prespecified position.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a diagram illustrating an installed position of a state monitor apparatus according to an embodiment of the present disclosure;

FIG. 2 is a block diagram illustrating an overall configuration of the state monitor apparatus;

FIG. 3 is a functional block diagram of a state monitor ECU;

FIG. 4 is a diagram illustrating an installation method of the state monitor apparatus;

FIG. 5 is a flowchart diagram illustrating a state monitor process;

FIG. 6 is a diagram illustrating a relationship between the capture timing for capturing images and the emission timing for emitting near-infrared lights;

FIGS. 7A, 7B, 7C are diagrams for explaining an effect of the embodiment; and

FIG. 8 is a diagram for explaining an effect of the embodiment.

### DETAILED DESCRIPTION

Hereafter, description will be given to a state monitor apparatus 1 according to an embodiment of the present disclosure with reference to the drawings.

<State Monitor Apparatus>

The state monitor apparatus 1 is mounted in a host vehicle AM that is defined as a vehicle to which the state monitor apparatus 1 is mounted. The host vehicle AM may be also referred to as only “the vehicle.” The state monitor apparatus 1 serves as so-called driver monitoring system to monitor an occupant such as a driver of the vehicle to achieve a safe driving of the vehicle.

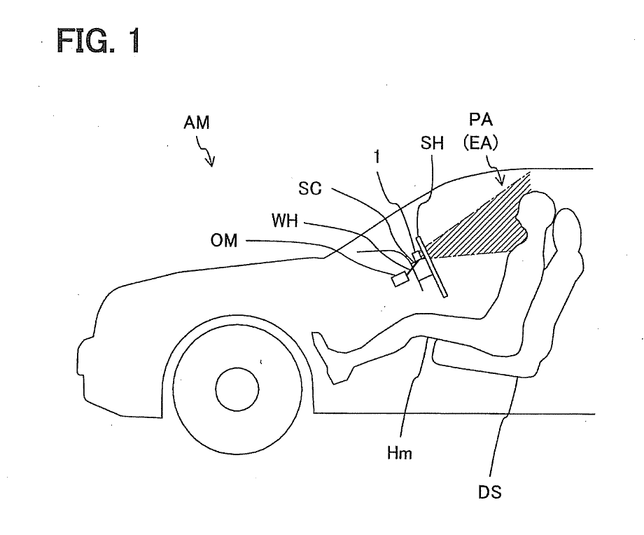

With reference to FIG. 1, the state monitor apparatus 1 is installed above a steering column SC that connects with a steering wheel SH, and is connected to other in-vehicle apparatus OM via a wire harness WH.

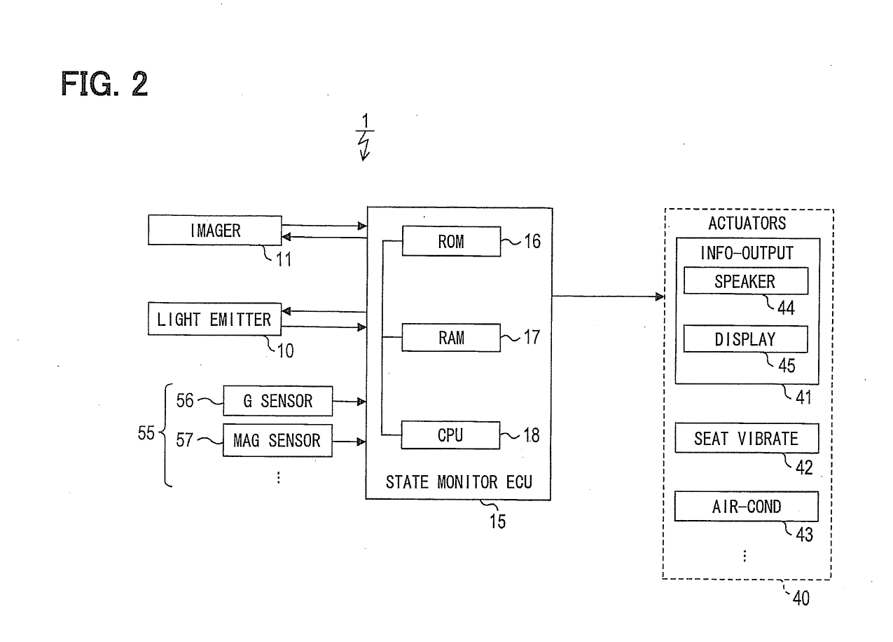

With reference to FIG. 2, the state monitor apparatus 1 includes the following: a light emitter 10 to emit lights having wavelengths containing near-infrared lights (hereinafter, also referred to as near-infrared lights) and irradiates a defined radiated area PA (refer to FIG. 1); an imager 11 to capture an image PI; actuators 40 including various in-vehicle apparatuses mounted in the vehicle AM; and a state monitor ECU (electronic control unit) 15 to monitor a state of the occupant Hm of the vehicle AM while controlling the components 10, 11, 40 based on results of image-processing images captured by the imager 11.

The actuators 40 include: an information-output portion 41 to output information according to control signals CS from the state monitor ECU 15; a seat vibrator 42 that is built in a driver seat DS (refer to FIG. 1) of the vehicle AM and vibrates the seat DS according to control signals CS from the state monitor ECU 15; a steering wheel vibrator (unshown); and an air-conditioning control apparatus 43 to control an air-conditioning apparatus mounted in the vehicle AM. The information-output portion 41 includes a speaker 44 for outputting sounds and a display 45 such as a liquid crystal display and an indicator that indicates different information items by changing display modes, respectively.

The light emitter 10 is a light emitting diode (LED) which emits near-infrared lights according to control instructions CO from the state monitor ECU 15; it is disposed at a prespecified position to permit a defined irradiated area PA to receive or be irradiated with the near-infrared lights. The defined irradiated area PA refers to an area where a face of the occupant Hm of the vehicle AM may be located. The defined irradiated area PA may be an area near a headrest of the driver seat DS, for example. The prespecified position may be a position above a column cover CC of a steering column SC, for example.

The imager 11 captures an image PI with an image sensor and includes a known camera that is composed of an image sensor, such as CCD and CMOS, and peripheral electronic circuits such as an optical lens, an optical filter, and a power source. The imager 11 is disposed at a prespecified position to have as a captured area a defined captured area EA to cover the defined irradiated area PA. That is, the captured area of the imager 11 includes an area where the face of the occupant Hm of the vehicle AM is usually located. The gain or exposure period or time of the image sensor may be controlled in an automatic mode or a manual mode depending on the surrounding environments. The image sensor has a communication function to change the image-capture timing as needed.

The state monitor ECU 15 includes a microcomputer having a ROM 16 storing data and programs constantly even if the power source is disconnected, a RAM 17 storing data temporarily, and a CPU 18 processing according to programs stored in the ROM 16 or RAM 17.

The state monitor ECU 15 connects with a communication link to receive a signal from sensors 55 or a different in-vehicle external sensor to detect installed position information about the installed position of the state monitor apparatus 1.

The sensors 55 include, in addition to a well-known G sensor 56 and magnetometric sensor 57 (e.g., magnetic proximity switch), at least one of a well-known pressure sensor, ultrasonic sensor, optical sensor, and GPS (Global Positioning System) receiver; alternatively, the sensors 55 may receive a signal from a different sensor that is installed separately.

The ROM 16 of the state monitor ECU 15 stores a program that monitors a state of the occupant Hm, and provides a caution or warning when the occupant Hm is in an un-safe state by controlling the actuators 40 to interface with the occupant Hm to realize the safe travel of the vehicle AM, while executing a state monitor process to restrict the emission of the near-infrared lights by the light emitter 10 when detecting that the installed position of the state monitor apparatus 1 is displaced from the fixing position, namely, when detecting that the installed position of the light emitter 10 is displaced from the prespecified position based on the detection results of the sensors 55. In the present embodiment, the fixing position of the state monitor apparatus 1 refers to a prespecified position on the steering column SC to permit the installed positions of the light emitter 10 and the imager 11 to accord with the respective prespecified positions.

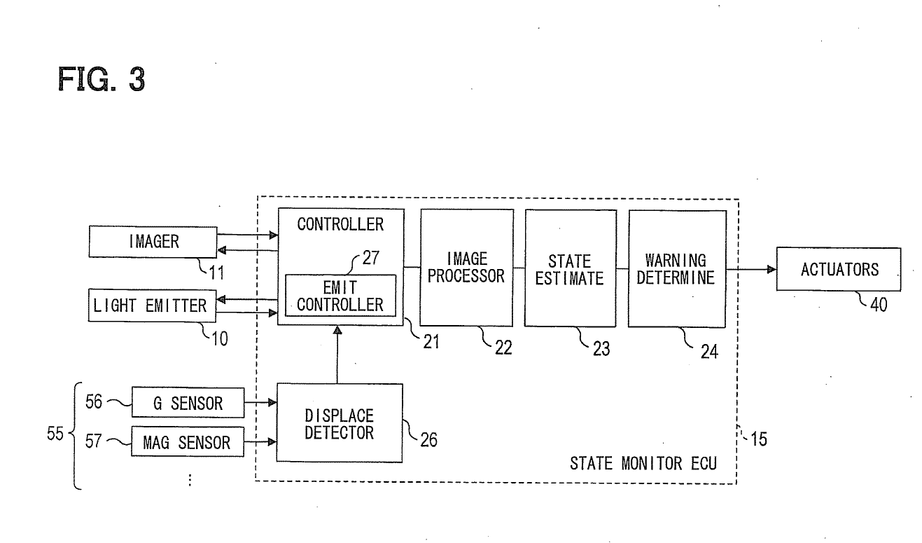

With reference to FIG. 3, the state monitor ECU 15 is illustrated as a functional block diagram. Naturally, those functional blocks are achieved by using the CPU 18, the RAM 17, and the ROM 16 in FIG. 2. The state monitor ECU 15 includes a controller 21 to control one of the emission of the near-infrared lights by the light emitter 10 and the capturing of the image PI by the imager 11; an image processor 22 that applies image processing to an image PI captured; a state estimate portion 23 that estimates a state of the occupant Hm of the vehicle AM based on the image PI to which the image processing is applied by the image processor 22; and a warning determination portion 24 that controls the actuators 40 based on the estimated result by the state estimate portion 23.

The state monitor ECU 15 further includes a displacement detector 26 that detects whether the installed position of the state monitor apparatus 1 is displaced from the fixing position (i.e., whether the installed position of the light emitter 10 is displaced from the prespecified position). Furthermore, the displacement detector 26 may also be referred to as a position acquisition section, device, or means. In addition, the controller 21 of the state monitor ECU 15 includes an emission controller 27 that controls an emission of the near-infrared light by the light emitter 10 based on the detection result by the displacement detector 26. Furthermore, the emission controller 27 may also be referred to as an emission control section, device, or means.

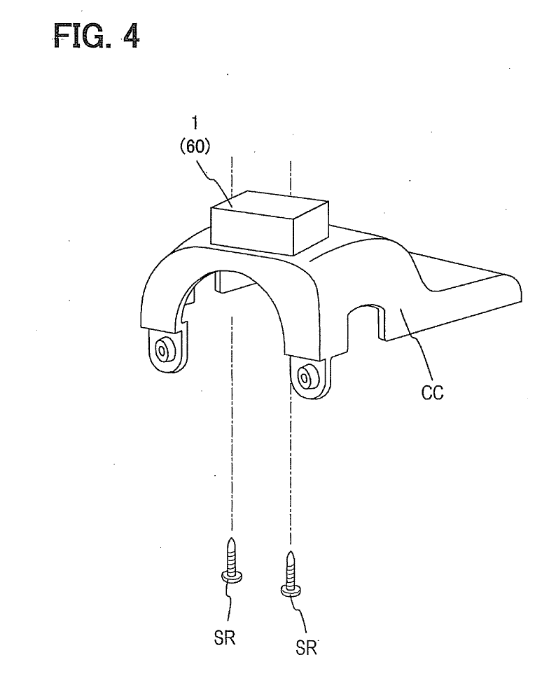

With reference to FIG. 4, the installation method of the state monitor apparatus 1 of the present embodiment will be explained. The light emitter 10, the imager 11, and the state monitor ECU 15 are contained in a single housing 60, that is fixed to the front side of the column cover CC covering the steering column SC with a fastening element such as screws SR fastening from the rear side of the cover CC, precluding a usual occupant Hm from easily detaching the housing 60.

The wire harness WH connecting the state monitor apparatus 1 to the different in-vehicle apparatus OM is provided to enable the near-infrared light from the light emitter 10 to radiate within a tolerance range from the defined irradiated area PA even when the installed position of the state monitor apparatus 1 is displaced from the fixing position (i.e., when the installed position of the light emitter 10 is displaced from the prespecified position).

The tolerance range refers to a design range, e.g., based on the experiments to permit the face of the driver Hm to be constantly contained within the irradiated area that the light emitter 10 irradiates with the near-infrared lights even when the installed position of the light emitter 10 is displaced from the prespecified position. This range indicates a three-dimensional space seen from the imager 11, which is defined by not only a field angle but also a distance between the imager 11 and the area where the occupant's face is present.

The wire harness WH may be provided such that an effective length is adjusted. Such adjustment may be realized by adjusting the actual length of the wire harness WH or clamping the wire harness WH.

Adjusting the length may be achieved by adjusting the length of the longest wire among a plurality of wires included in the wire harness WH. Clamping the wire harness WH may be useful to make the length of the wire harness WH longer than needed so as to increase the efficiency in assembling it to the vehicle while preventing the imager 11 or the light emitter 10 from being displaced significantly.

Furthermore, more than one wire harness WH may be provided. In such a case, adjusting each of the wire harnesses WH may prevent the imager 11 and the light emitter 10 from being displaced or deviating while preventing the state monitor apparatus 1 from rotating or preventing the optical axis of the imager 11 or the light emitter 10 from deviating.

<State Monitor Process>

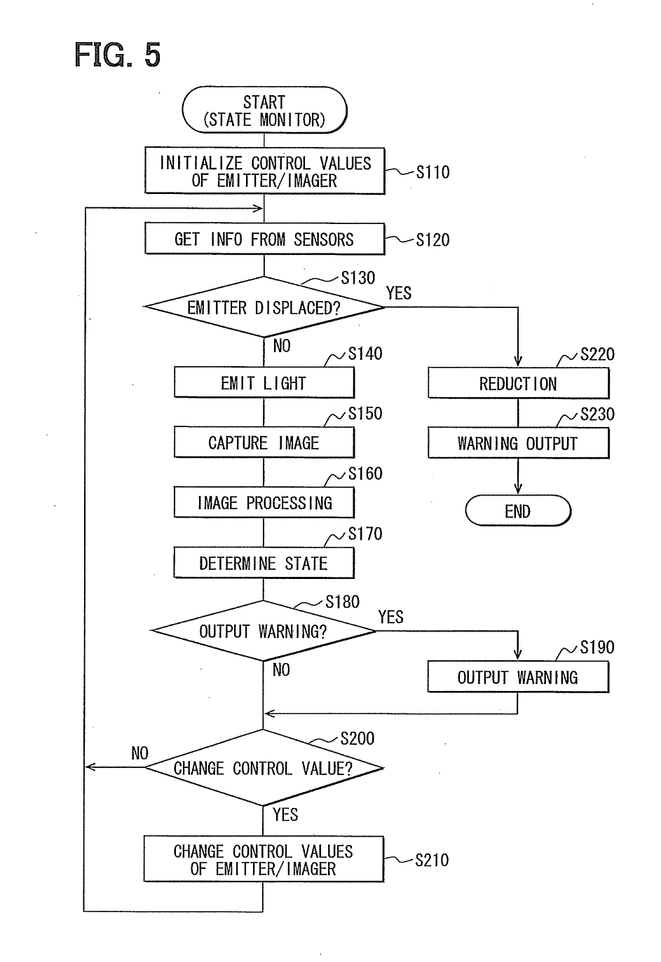

With reference to FIG. 5, the following will explain a flowchart of a state monitor process executed by the state monitor ECU 15. It is further noted that a flowchart in the present application includes sections (also referred to as steps), which are represented, for instance, as S110. Further, each section can be divided into several sub-sections while several sections can be combined into a single section. Furthermore, each of thus configured sections can be referred to as a device, module, processor, or means and achieved not only (i) as a software section in combination with a hardware unit (e.g., computer), but also (ii) as a hardware section, including or not including a function of a related apparatus. Further, the hardware section may be inside of a microcomputer.

This state monitor process is started when electric power is supplied to the state monitor apparatus 1, i.e., when the ignition switch is turned into an on state. At S110, after start-up, a control value of the light emitter 10 and a control value of the imager 11 are set to respective predetermined initial values.

The control value of the light emitter 10 includes at least the level or strength of the near-infrared light emitted by the light emitter 10. This level of the near-infrared light is within a fixed control range, the upper limit of which satisfies an exempt level stipulated in IEC (International Electrotechnical Commission) 62471 to certainly secure the living body safety of the occupant against lights. In contrast, the lower limit of the fixed control range is obtained previously with experiments to capture an image PI suitable for image processing, and specified to satisfy the minimum level in the exempt level stipulated in IEC 62471 to certainly secure the living body safety of the occupant against lights.

That is, the lower limit of the control range is specified as a minimum light quantity as follows. No lights other than the light from the state monitor apparatus 1 exist in a space; the face of the occupant's Hm is present at the shortest distance (for example, 20 cm) of the depth of field that is a design value of an imaging lens; and the face has a skin with a typical reflectance rate at the near-infrared light having a peak wavelength of 850 nm. Under such premises, in order to obtain an image suitable for image processing, the image capture conditions or parameters, such as an exposure time, a gain, and a light quantity, are experimentally determined; thereby, the minimum light quantity is obtained from the parameters determined.

Furthermore, the control value of the imager 11 includes an exposure period or time and a gain; the control value stipulates a specification range that is obtained previously with experiments to capture an image PI suitable for image processing. Yet furthermore, the control value of the imager 11 includes a depth of field that is desirable to be within a range of 20 to 100 cm for a usual vehicle.

At S120, a detection signal is acquired from the sensors 55. At S130, based on the detection signal acquired, it is determined whether the stop state takes place where a function of the state monitor apparatus 1 is intentionally stopped. At S130, whether the stop state takes place or not is determined. In other words, it is determined whether the installed position of the state monitor apparatus 1 is displaced from the fixing position, namely, whether the installed position of the light emitter 10 is displaced from the prespecified position. Specifically, an output from the G sensor 56 is processed to cancel out an acceleration produced by the vibration of the vehicle AM; the above determination is affirmed when the output processed becomes greater than a predetermined threshold value. That is, when the acceleration beyond a predetermined value is applied to the state monitor apparatus 1, it is determined that the stop state takes place or the installed position of the light emitter 10 is displaced from the prespecified position. The determination as to whether the installed position of the light emitter 10 is displaced from the prespecified position by detecting a force applied to the state monitor apparatus 1 using the sensors 55 includes the determination based on an output from a pressure sensor which detects a surrounding pressure of the state monitor apparatus 1.

In addition, the determination as to whether the installed position of the light emitter 10 is displaced from the prespecified position includes the determination based on an output from the magnetometric sensor 57. That is, in the present embodiment, the magnetometric sensor 57 being a magnetic proximity switch may detect that the installed position of the light emitter 10 is displaced from the prespecified position. The information to directly determine whether the installed position of the light emitter 10 is displaced from the prespecified position may include results of transmission and reception of ultrasonic waves radiated to the state monitor apparatus 1 from an ultrasonic sensor installed at a predetermined position; detection results by an optical sensor such as a photo-diode and a photo-coupler installed at a predetermined position; or coordinates of the state monitor apparatus 1 detected by a GPS receiver installed within the state monitor apparatus 1. In addition, another apparatus mounted in the vehicle AM may be used to capture an image to detect the installed position of the state monitor apparatus 1 and transmit the result to the state monitor apparatus 1 via a communication means such as the CAN. The other apparatus may include a camera for air bag deployment control or a camera for security installed on a ceiling or an overhead module; or an infrared sensor that senses infrared radiation from the occupant to control air conditioning.

Yet further, the determination as to whether the installed position of the light emitter 10 is displaced from the prespecified position may be based on an image PI captured by the imager 11. That is, a subject object such as a steering wheel SH, a pillar, a ceiling, a side window, or a rear window may be present at a normal position within an image PI captured by the imager 11 when the installed position of the imager 11 accords with the prespecified position. When the subject object is not recognized as being positioning at the normal position in the image PI, it is determined that the installed position of the light emitter 10 is displaced from the prespecified position.

Returning to the state monitor process, when it is determined that the installed position of the light emitter 10 is displaced from the prespecified position (S130: YES), the stop state is determined to take place, triggering the execution of a reduction process to be mentioned later at S220. In contrast, when it is determined that the installed position of the light emitter 10 is not displaced from the prespecified position (S130: NO), the stop state is determined not to take place, advancing the process to S140. At S140, a control instruction CO is outputted to the light emitter 10 to irradiate the defined irradiated area PA with the near-infrared lights. Then, at S150, the imager 11 captures an image PI of the defined captured area EA.

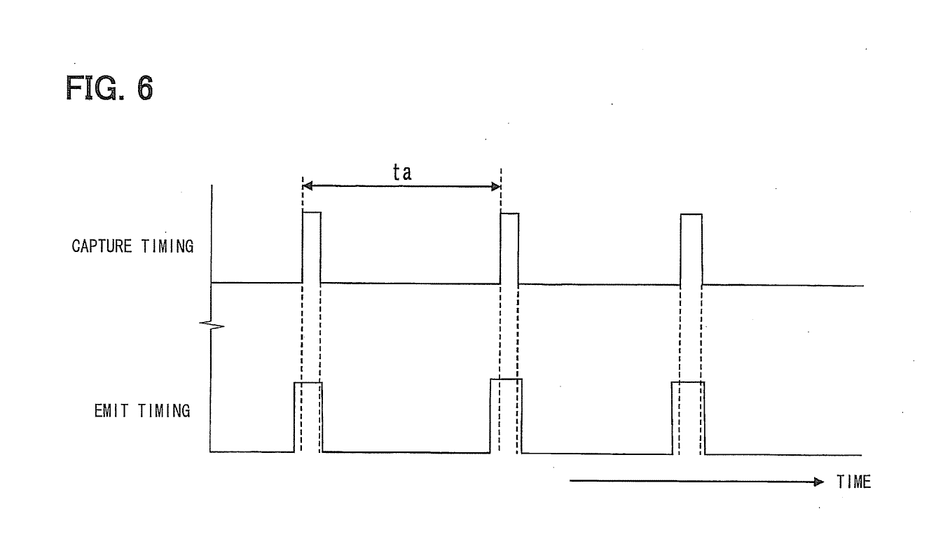

In the present embodiment, with reference to FIG. 6, the emission timing at which the light emitter 10 emits near-infrared lights and the capture timing at which the imager 11 captures an image PI are designed such that the period of the emission for which the light emitter 10 emits near-infrared lights is synchronized with the exposure period of the imager 11. This synchronization signifies that although the emission period from lighting on to lighting out need not accord with an exposure period fully, the emission period is desirably specified to be a little longer than the exposure period, as illustrated in FIG. 6. This is effective in raising the S/N ratio in capturing an image in the vehicle compartment, in order to preventing disturbance noise lights such as sunlight from deteriorating an image quality. FIG. 6 exemplifies the timing chart using an image sensor of a global shutter; however, the timing chart may be applied similarly to an image sensor of a rolling shutter, without need to be limited. It is noted that in FIG. 6, the sign “ta” signifies an image capture interval of an image PI by the imager 11, and is an interval at which S150 is repeatedly executed in a series of S130 to S210 in FIG. 5. The capture timing may be a fixed period ta or may be controlled from an external source to capture an image only when the state monitor ECU 15 instructs.

At S160, an image processing is applied to the image PI captured at S150.

The image processing may be a known one to derive the opening degree of the eyes of the occupant's Hm or to detect the direction of the sight line of the occupant's Hm. At S170, a state determination to determine the state of the driver Hm is executed as a known determination of the degree of arousal of the driver's Hm or looking aside of the driver Hm during the driving, based on the result of the image processing at S160.

Then, at S180, it is determined about the presence or absence of the necessity of outputting a warning to the occupant Hm based on the result of the state determination at S170. For example, when the degree of arousal of the driver Hm is less than a predetermined threshold value, i.e., it is estimated that the driver Hm had the sleepiness greater than a predetermined level, or when it is inferred that the driver Hm looks aside while driving, it is determined that outputting a warning is necessary. Even when the state continues where the face is not directed ahead of the vehicle, whether the driver Hm is looking aside or is making a safety check may not be correctly determined only with the state monitor apparatus 1. Thus, it is more desirable to determine it using simultaneously other information such as a vehicle speed or information from a periphery monitor apparatus.

When it is necessary to output a warning (S180: YES), a control signal CS is outputted to the actuators 40 to output a warning at S190. For example, the warning outputted at S190 when the degree of arousal of the driver Hm is less than the threshold value includes a warning to urge to rest outputted by the information-output portion 41; a vibration applied to the driver seat DS via the seat vibrator 42; a vibration applied to the steering wheel WH; or a cold blast towards the driver Hm via the air conditioning control apparatus 43. Which one of the actuators 40 is selected may be determined suitably depending on the degree of arousal, the previous designation by the occupant Hm, or the consideration of additional information from other apparatuses. In addition, the arousal effect may not be obtained even if the actuators 40 are used. In such a case, another effective countermeasure may be used such that the strength is changed, or the selection of the actuators 40 may be changed in order. In addition, the warning outputted at S190 when the driver Hm looks aside while driving may include a notice by voice outputted by the information-output portion 41; a vibration applied to the driver seat DS via the seat vibrator 42; a cold blast towards the driver Hm via the air conditioning control apparatus 43.

When outputting a warning is unnecessary (S180: NO), the process advances to S200, without executing S190. At S200, it is determined whether to change at least one of the control value of the light emitter 10 and the control value of the imager 11. That is, using a known process, it is determined whether the control value of the light emitter 10 and the control value of the imager 11 which are set at present are suitable for determining the state determination of the driver Hm using the image processing based on the image PI captured at S150. When the control value of the light emitter 10 and the control value of the imager 11 are not suitable (S200: YES), at least one of the control value of the light emitter 10 and the control value of the imager 11 is changed to an optimum value at S210.

The change of the control value at S210 may be made according to a table which associates a relationship between the states of the image PI and optimum values of the control values, which is obtained based on previous experiments etc. For instance, it is determined whether the pixel value of a part or the whole of the face of the occupant Hm obtained based on the image processing is within a predetermined range. When the pixel value is smaller than the threshold value, the increase of the pixel value at the next image capture is attempted by enlarging the analog gain, lengthening the exposure period, or strengthening the emission intensity. Such control may be desirable to converge step by step from the viewpoint as follows. The real vehicle environment may vary significantly optimal image capture conditions for respective image capture frames under various dominant causes. Changing at once the setting value on the control table may cause a fluctuation such as hunting.

After S210, the process returns to S130 via S120. Also when the change of the control value is unnecessary (S200: NO), the process returns to S130.

When it is determined that the installed position of the light emitter 10 is displaced from the prespecified position (S130: YES), the reduction process is executed (S220). The reduction process at S220 is to reduce the level of the near-infrared lights from the light emitter 10 to be less than the lower limit of the control range of the near-infrared lights. Specifically, the reduction process of the present embodiment issues a control instruction CO to instruct the light emitter 10 to stop the emission of the near-infrared lights.

Without need to be limited thereto, the reduction process may be differently executed. Without stopping the emission of the near-infrared lights by the light emitter 10, the reduction process may issue another control instruction CO to instruct the light emitter 10 to reduce the level of the near-infrared lights emitted to be less than the lower limit of the control range of the near-infrared lights.

In such a case, reducing the level may be made by reducing the current value indicated in the control instruction CO. When the control instruction CO includes pulsed signals, the duty of the signals may be reduced. Furthermore, when the control instruction CO includes signals with periodicity, the period may be reduced, i.e., the frequency of the emission may be reduced. Furthermore, the above countermeasures may be combined to realize the object.

Then, at S230, a control signal CS is outputted to the actuators 40 to output a warning. The output of the warning at S230 includes a message to indicate the unnecessity of the emission of the near-infrared lights, outputted by the information-output portion 41; or a message to indicate the displacement of the installed position of the state monitor apparatus 1 from the fixing position, outputted by the information-output portion 41. Furthermore, the warning at S230 may include a vibration applied to the driver seat DS via the seat vibrator 42; and a cold blast towards the driver Hm via the air conditioning control apparatus 43.

The present state monitor process is then ended. After S230, the process may return to S120 to wait until the determination of the stop state is cancelled.

The condition to end the present state monitor process need not be limited to the above. It may be when the ignition switch is turned into an off state by the occupant Hm in the middle of the process. It may be when the on/off switch that may be dedicated for the state monitor apparatus 1 is turned into an off state by the occupant Hm.

As mentioned above, in the state monitor process according to the present embodiment, it is determined whether the stop state which should stop the function of the state monitor apparatus 1 takes place based on the detection signal from the sensor 55, or it is determined whether the installed position of the state monitor apparatus 1 is displaced from the fixing position or prespecified position. When the result of the determination indicates that the installed position of the state monitor apparatus 1 is not displaced from the fixing position, it is determined that the stop state does not take place. The defined irradiated area PA is irradiated by the light emitter 10 with the near-infrared lights, and the image PI is captured, enabling the monitoring of the state of the driver Hm.

In contrast, when the result of the determination indicates that the installed position of the state monitor apparatus 1 is displaced from the fixing position, it is determined that the stop state takes place. In this case, the reduction process and the warning process are executed as a specific restriction process in the present embodiment.

### Effect of Embodiment

According to the state monitor apparatus 1, when the stop state takes place, the level of the near-infrared lights emitted by the light emitter 10 may be reduced to be less than the lower limit of the control range of the near-infrared lights. As a result, the stop state taking place precludes the near-infrared lights from radiating with a strength level higher than needed.

In particular, in the state monitor apparatus 1 of the present embodiment, when the stop state takes place, the emission of the near-infrared lights by the light emitter 10 is prohibited. Therefore, when the stop state takes place, the near-infrared lights having a strong strength more than needed can be more certainly prevented from radiating.

In addition, when the stop state takes place in the state monitor apparatus 1, a warning is outputted which indicates that the emission of the near-infrared lights is unnecessary, or the installed position of the state monitor apparatus 1 is displaced from the fixing position or prespecified position. Therefore, the occupant Hm of the vehicle AM may recognize such a state, possibly canceling the stop state by restoring the state monitor apparatus 1 to the prespecified position as needed.

Such a configuration of the state monitor apparatus 1 may reduce the electricity consumption due to the emission of the near-infrared lights with a strong strength. According to the state monitor apparatus 1, when the stop state takes place, the level of the near-infrared lights emitted by the light emitter 10 may be reduced to be less than the lower limit of the control range of the near-infrared lights, enhancing the safety of the state monitor apparatus 1. Since the light emitter 10 does not emit lights, the heating of the surrounding area is suppressed to help prevent the temperature increase of the apparatus 1 from occurring. In addition, even when the face of the occupant Hm approaches the state monitor apparatus 1 closer than needed, the occupant Hm may be subjected to the much lower level with a significant margin within the range of the exempt level for the living body safety stipulated in IEC 62471.

When determining that a stop state takes place, the state monitor apparatus 1 of the present embodiment executes a reduction process to stop the emission of the near-infrared lights by the light emitter 10. When the stop state is thereafter canceled to enable an operation of the state monitor apparatus 1, only the emission of the near-infrared lights by the light emitter 10 is permitted, restoring the state monitor apparatus 1 to an operable state quickly.

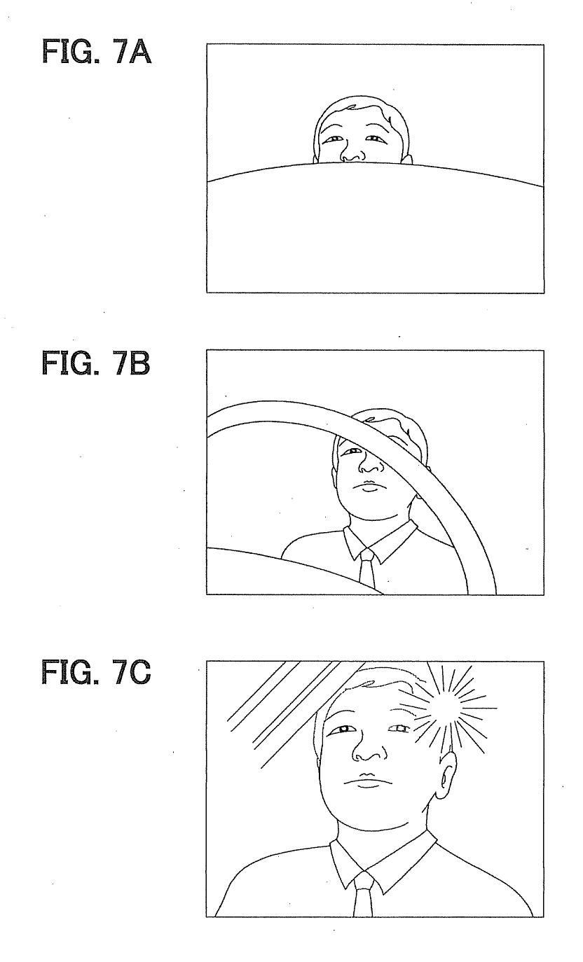

Further, the state monitor apparatus 1 is connected to other in-vehicle apparatus OM via the wire harness WH. Suppose that the length of this wire harness WH is too long, and the installed position of the state monitor apparatus 1 is displaced from the prespecified position. In such a case, the following unintended situations may occur. In particular, when the installed position of the imager 11 may be displaced from the prespecified position, the column cover CC and the steering wheel SH may be reflected in the image PI together with the face of the occupant Hm serving as a monitor object, respectively, as illustrated in FIGS. 7A, 7B. Further, in particular, when the installed position of the light emitter 10 is displaced from the prespecified position, the unnecessary lights may be reflected in the image PI, as illustrated in FIG. 7C.

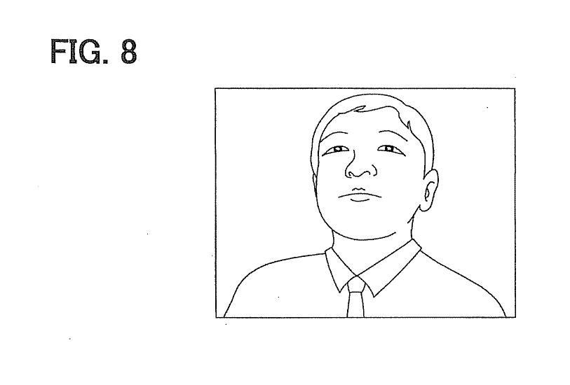

In response thereto, the wire harness WH of the present embodiment is provided or installed such that even when the installed position of the state monitor apparatus 1 is displaced from the fixing position (i.e., when the installed position of the light emitter 10 is displaced from the prespecified position), the near-infrared light from the light emitter 10 to radiate within a tolerance range from the defined irradiated area PA. Thus, the image PI can be captured not to include an obstacle or unnecessary lights as illustrated in FIG. 8.

The same effect may be obtained not only by adjusting the length of the wire harness to be not longer than needed, but also by clamping the wire harness near the state monitor apparatus 1. The state monitor apparatus 1 is fixed by a fastening element SR from the rear face of the column cover CC covering the steering column SC. Such a fastening structure may certainly suppress the installed position of the state monitor apparatus 1 from being displaced from the fixing position or prespecified position, irrespective of intention or negligence.

### Other Embodiments

Up to this point, description has been given to an embodiment of the present disclosure. However, the present disclosure is not limited to the above embodiment, and it can be variously embodied as long as not departing from the subject matter of the present disclosure.

In the above embodiment, the stop state is determined from that the installed position of the light emitter 10 is displaced from the prespecified position. Without need to be limited thereto, the stop state may be determined from that the installed position of the imager 11 is displaced from the prespecified position or from that the steering wheel SH is not attached to the steering column SC.

In the former case, the information acquired at S120 of the state monitor process needs the information about the installed position of the imager 11. In the latter case, the steering wheel SH of the vehicle AM is not provided; thus, the vehicle AM has a very low possibility to be driven. In such a case, the light emitter 10 can be prohibited from emitting near-infrared lights. As a result, even when the steering wheel SH is not attached to the steering column SC, the near-infrared lights with a strength more than needed are prevented from radiating. This can reduce the electricity consumption.

The determination as to whether the steering wheel SH is not attached to the steering column SC is made as follows. For example, when the steering wheel SH is reflected in the specified region in the image PI, the steering wheel SH is determined to be attached in the steering column SC. For example, when the steering wheel SH is not reflected in the specified region in the image PI, the steering wheel SH is determined not to be attached in the steering column SC. Further, the determination as to whether the steering wheel SH is not attached to the steering column SC may be made based on the detection signal from the various switches which detect either contact or non-contact.

In the above embodiment, two of the reduction process (S220) and the warning output (S230) are executed in the state monitor process when the installed position of the light emitter 10 is displaced from the prespecified position (S130: YES). Either one of the reduction process (S220) and the warning output (S230) may be executed as the process executed when the installed position of the light emitter 10 is displaced from the prespecified position.

Furthermore, in the above embodiment, the reduction process is to stop the emission of the near-infrared lights by the light emitter 10. Without need to be limited thereto, shutting down the electric power supply to the state monitor apparatus 1 may be executed as the reduction process. Alternatively, while maintaining the imager 11 and the state monitor ECU 15 in a standby state, the electric power supply to the light emitter 10 may be shut down. In particular, in the latter case, the imager 11 and the state monitor ECU 15 in the state monitor apparatus 1 are maintained in the standby state. Thus, when the stop state is canceled to thereby enable the operation of the state monitor apparatus 1, only starting the light emitter 10 permits the state monitor apparatus 1 to recover to the operable state quickly.

Further, the execution condition to execute either the reduction process (S220) or the warning output (S230) need not be limited to the case when the installed position of the light emitter 10 is displaced from the prespecified position. It may be the case when the steering wheel SH is not attached to the steering column SC.

Further, in the above embodiment, the light emitter 10 is a light emitting diode (LED) to emit near-infrared lights. Without need to be limited thereto, the light emitter 10 may be any device as long as it emits near-infrared lights according to a control instruction CO from the state monitor ECU 15.

Further, in the above embodiment, the timing at which the light emitter 10 emits near-infrared lights and the timing at which the imager 11 captures an image PI are designed or provided such that while the near-infrared-light emission period of the light emitter 10 is longer than the exposure period of the imager 11, the image capture (from the exposure start to the exposure end) of image PI by the imager 11 is executed within the near-infrared-light emission period. Without need to be limited thereto, the near-infrared-light emission period of the light emitter 10 may not be longer than the exposure period of the imager 11.

Furthermore, the light emitter 10 may control the state monitor ECU 15 to constantly emit near-infrared lights. In the above embodiment, the state monitor apparatus 1 is installed on the steering column SC. Without need to be limited thereto, the state monitor apparatus 1 may be installed at another position. For example, it may be installed on a dashboard, on a meter, or inside of the meter. That is, as long as the state monitor apparatus 1 is installed to irradiate the defined irradiated area PA with near-infrared lights, and capture an image PI of the defined captured area EA, it may be installed at any position.

Further, in the above embodiment, the light emitter 10 and the imager 11 are housed or stored in the housing 60 as one body and installed on the column cover CC of the steering column SC. Without need to be limited thereto, the light emitter 10 and the imager 11 may be disposed separately.

Furthermore, the sensor 55 may be dedicated for the state monitor apparatus 1 or used in common in another apparatus mounted in the vehicle AM. In the former case, the sensors 55 may be provided in the state monitor apparatus 1. In addition, when the sensors 55 are used in common in the other apparatus mounted in the vehicle AM, the signal line from the sensors 55 may be connected to the state monitor apparatus 1. Furthermore, the sensors 55 may be provided outside of the vehicle AM.

In the above embodiment, the starting condition of the state monitor process is deemed as the time when the ignition switch is turned into an on state. Without need to be limited thereto, it may be deemed as the time when the vehicle AM is unlocked, or it may be deemed as the time when an initial stage of the state monitor apparatus 1 after turning on the ignition switch (IG).

Further, in the above embodiment, the state monitor apparatus 1 is mounted in the vehicle. It may be mounted in a bicycle or a railroad vehicle. That is, the state monitor apparatus 1 may be installed in any vehicle.

[Functions]

The light emitter 10 may also function as a light emission device or means; the imager 11 may also function as an image capture device or means. The state monitor ECU 15 may also function as a state monitor section, device, or means at S140 to S210 in the state monitor process. The state monitor ECU 15 may also function as a state determination section, device, or means at S130 in the state monitor process.

The state monitor ECU 15 may also function as a restriction execution section, device, or means at S220 and S230 in the state monitor process. The state monitor ECU 15 may also function as an emission control section, device, or means at S220. The state monitor ECU 15 may also function as an information-output control section, device, or means at S230. The state monitor ECU 15 may also function as a position acquisition section, device, or means at S120 in the state monitor process. Further, the position acquisition section may include a steering-wheel detection section, device, or means to detect whether a steering wheel is attached in a steering column of an automobile.

While aspects of the disclosure described herein are already recited in the preceding summary, further optional aspects thereto may be set out as follows.

For instance, as an optional aspect of the disclosure, the restriction execution section may include an emission control section to perform as the restriction process a reduction process to reduce a level of the near-infrared light emitted by the light emitter to a level lower than a predetermined level when the stop state is determined to take place.

The above predetermined level refers to the lower limit of the control range of the near-infrared lights emitted from the light emitter when the state monitor apparatus is normally operated, i.e., when the stop state does not take place. For instance, in contrast, the upper limit of the control range is determined to satisfy an exempt level (i.e., no danger level) stipulated in IEC (International Electrotechnical Commission) 62471 to certainly secure the living body safety in the occupant against lights.

As explained above, the reduction process is executed as the restriction process; therefore, the emission strength of the near-infrared lights may be reduced certainly under the stop state taking place.

As an optional aspect of the disclosure, the emission control section may execute as the restriction process a prohibition process to prohibit emitting the near-infrared light by the light emitter when the stop state is determined to take place.

Prohibiting the emission of the near-infrared lights is executed as the restriction process, therefore preventing the light emitter from emitting the near-infrared lights under the stop state taking place. As a result, the reduction of the electricity consumption by emitting the near-infrared lights may be enhanced.

As an optional aspect of the disclosure, the restriction execution section may include an information-output control section to execute as the restriction process an information-output process to output information indicating that emitting the near-infrared light by the light emitter is unnecessary when the stop state is determined to take place.

Thus, the occupant of the vehicle can recognize that the stop state takes place, and may therefore intentionally reduce the function of the light emitter. As a result, the notification of the stop state taking place precludes the near-infrared lights from radiating with a strength level higher than needed. Further, the stop state may be cancelable by the occupant to return or restore the state monitor apparatus to the prespecified position.

As an optional aspect of the disclosure, a position acquisition section may be included to acquire installed position information on an installed position of the light emitter. Herein, the stop state may be determined to take place when the installed position acquired indicates that the installed position of the light emitter is displaced from the prespecified position of the light emitter.

When the installed position of the light emitter is displaced from the prespecified position, the function as the state monitor apparatus may not be practically achieved. Under the above optional configuration, the condition for determining the restriction process to restrict the function of the light emitter is presumed as the displacement of the light emitter from the prespecified position.

The installed position information includes information for determining whether the light emitter is displaced from the prespecified position. For instance, the installed position information may include a magnitude of an acceleration, which is applied to the state monitor apparatus (i.e., the light emitter) and detected with a well-known acceleration sensor, or a result of determining whether the installed position of the state monitor apparatus (i.e., the light emitter) is displaced based on the change of the air pressure around the state monitor apparatus (i.e., the light emitter) detected with a well-known pressure sensor. Those are detected only when the IG switch is in an on state, and may not be detected when the displacement occurs due to an intentional or unintentional force under the off state of the IG switch. Further, the installed position information may be information, which directly indicates whether the installed position of the light emitter is displaced from the prespecified position and is acquired from a well-known magnetometric sensor, an ultrasonic sensor (for example, ultrasonic sonar), an optical sensor, or an image-processing result of the image captured by the imager. In addition, an electric contact may be used. In this case, when the light emitter is not in a normal position, the state monitor apparatus is made into the stop state or no-power supply state.

The above installed position detecting means may be activated simultaneously when doors of the vehicle are opened, or during the initial stage of the state monitor apparatus after the IG switch is turned into the on state. Further, similarly, when the installed position of the imager is displaced from the prespecified position, the function as the state monitor apparatus may not be practically achieved. Therefore, when the position acquisition section acquires the installed position of the imager and determines that the installed position acquired is displaced from the prespecified position, the stop state may be determined. In such a case, the restriction execution section may execute the specific restriction process to reduce the function of the light emitter, or may reduce the function of the imager as well or separately.

As an optional aspect of the present disclosure, the vehicle may include an automobile. The apparatus may further include a steering-wheel detection section to detect whether a steering wheel is attached in a steering column of the automobile. Herein, when the steering-wheel detection section detects that the steering wheel of the automobile is not attached in the steering column, the stop state may be determined to take place.

Thus, the conditions for determining the restriction process to reduce the emission of the near-infrared lights with a strength more than needed may be presumed to be a state where the steering column is not equipped with the steering wheel.

It is noted that the determination of whether the steering column is equipped with the steering wheel may be made based on detection signals from the various switches which detect the contact or non-contact state, or the result of the image processing of the image of an image-capture target being the steering wheel being attached in the steering column.

As an optional aspect of the present disclosure, the light emitter, the imager, the state monitor section, and the state determination section may be physically or mechanically contained in a single housing. The single housing may be connected with an in-vehicle unit using a wire harness such that an area irradiated by the light emitter with the near-infrared light is maintained within a tolerance range from the defined irradiated area even when the installed position of the light emitter is displaced from the prespecified position.

It is noted that when the installed position of the light emitter is displaced from the prespecified position but still within the tolerance range, the face of the occupant as a monitor object usually exists in the defined irradiated area of the near-infrared lights emitted by the light emitter. This tolerance range may be obtained from the experiments etc. This range indicates a three-dimensional space seen from the imager, which is defined by not only a field angle but also a distance between the imager and the area where the occupant's face is present. That is, when the image-capture target is out of the depth of field of the imager, the captured image may be recognized in a faded one. Thus, the depth of field may be desirably in a range of 20 to 100 cm in a usual vehicle.

To provide the wire harness as being mentioned above, the effective length of the wire harness may be specified or adjusted. Such adjustment may be realized by adjusting the actual length of the wire harness or clamping the wire harness.

Adjusting the length may be achieved by adjusting the length of the longest wire among a plurality of wires included in the wire harness. Clamping the wire harness may be useful to make longer than needed the length of the wire harness to increase the efficiency in assembling it to the vehicle while preventing the imager or the light emitter from being displaced significantly.

Furthermore, when there are more than one wire harness, the length of each wire harness may be adjusted. Further, the respective wire harnesses may be adjusted or controlled not to rotate or deviate an optical axis of the imager or the light emitter.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A state monitor apparatus in a vehicle, the apparatus comprising:
a light emitter to emit a light including a near-infrared light, the light emitter being to be installed at a prespecified position that permits the near-infrared light to be emitted towards a defined irradiated area that is defined as an area covering a face of an occupant of the vehicle;
an imager to capture an image of a defined captured area that is an area to cover at least partially the defined irradiated area;
a state monitor section to perform a monitoring to monitor an occupant state, which is a state of the occupant, based on a result from image-processing an image captured by the imager;
a state determination section to determine whether a stop state takes place which requires a stop of a function of the monitoring; and
a restriction execution section to execute a restriction process to restrict a function of the light emitter when the stop state is determined to take place by the state determination section.

2. The state monitor apparatus according to claim 1, wherein:
the restriction execution section includes an emission control section to perform as the restriction process a reduction process to reduce a level of the near-infrared light emitted by the light emitter to a level lower than a predetermined level when the stop state is determined to take place.

3. The state monitor apparatus according to claim 2, wherein:
the emission control section executes as the restriction process a prohibition process to prohibit emitting the near-infrared light by the light emitter when the stop state is determined to take place.

4. The state monitor apparatus according to claim 1, wherein:
the restriction execution section includes an information-output control section to execute as the restriction process an information-output process to output information indicating that emitting the near-infrared light by the light emitter is unnecessary when the stop state is determined to take place.

5. The state monitor apparatus according to claim 1, further comprising:
a position acquisition section to acquire installed position information on an installed position of the light emitter,
wherein:
the stop state is determined to take place when the installed position acquired indicates that the installed position of the light emitter is displaced from the prespecified position of the light emitter.

6. The state monitor apparatus according to claim 1, wherein:
the vehicle includes an automobile,
the apparatus further comprising:
a steering-wheel detection section to detect whether a steering wheel is attached in a steering column of the automobile,
wherein when the steering-wheel detection section detects that the steering wheel of the automobile is not attached in the steering column, the stop state is determined to take place.

7. The state monitor apparatus according to claim 1, wherein:
the light emitter, the imager, the state monitor section, and the state determination section are mechanically contained in a single housing; and
the single housing is connected with an in-vehicle unit using a wire harness such that an area irradiated by the light emitter with the near-infrared light is maintained within a tolerance range from the defined irradiated area when the installed position of the light emitter is displaced from the prespecified position.

8. A state monitor apparatus in a vehicle to monitor an occupant of the vehicle, the apparatus comprising:
a light emitter installed to a prespecified position for emitting a near-infrared light towards a compartment of the vehicle;
a camera capturing an image of an area which is irradiated by the light emitter with the near-infrared light;
means for determining whether the light emitter is displaced from the prespecified position; and
a controller to control an emission of the light emitter, the controller stopping or reducing the emission of the light emitter when the determining means determines that the light emitter is displaced from the prespecified position.

9. A method for controlling a state monitor apparatus in a vehicle, the apparatus including a light emitter installed to a prespecified position, the light emitter performing an emission to emit a near-infrared light towards a compartment of the vehicle,
the method comprising:
determining whether the light emitter is displaced from the prespecified position; and
prohibiting or reducing the emission of the light emitter when it is determined that the light emitter is displaced from the prespecified position.
